(19) United States
(12) Patent Application Publication
(10) Pub. No.: US 2026/0066983 A1
(43) Pub. Date: Mar. 5, 2026

(54) WIRELESS NETWORK ACCESS AND DATA COMMUNICATION USING PASSIVE TAG

(71) Applicant: Huawei Technologies Co., Ltd., Shenzhen (CN)

(72) Inventors: Xiuqiang Xu, Shanghai (CN); Lei Wang, Shanghai (CN); Jianglei Ma, Ottawa (CA)

(21) Appl. No.: 19/310,588

(22) Filed: Aug. 26, 2025

Related U.S. Application Data
(63) Continuation of application No. PCT/CN2023/079153, filed on Mar. 1, 2023.

(51) Int. Cl. H04B 7/155; H04W 72/044; H04W 76/10

(52) U.S. Cl. CPC H04B 7/155; H04W 72/0466; H04W 76/10

(57) ABSTRACT

In a wireless communication system, sometimes a network access procedure needs to be performed so that data may be communicated between a user equipment (UE) and a transmit-and-receive point (TRP). One example way to perform network access is to perform a random-access procedure. Performing a random-access procedure adds delay and possibly results in increased power consumption. In some embodiments herein, a UE includes a passive tag, such as a passive RFID tag. The passive tag backscatters a UE ID to the TRP. The TRP may then transmit an indication of the UE ID back to the UE. Data communication may then possibly occur between the TRP and the UE using the UE ID. The procedure may replace a random-access procedure.

### CROSS-REFERENCE TO RELATED APPLICATION

This application is a continuation of International Application No. PCT/CN2023/079153, filed on Mar. 1, 2023, which is hereby incorporated by reference in its entirety.

### TECHNICAL FIELD

The present application relates to wireless communication in a wireless network.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station or Node B. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a UE may wirelessly transmit information to a TRP in an uplink communication over a particular frequency (or range of frequencies) for a particular duration of time. The frequency and time duration are examples of resources, typically referred to as time-frequency resources. Other examples of resources may include resources in the spatial domain (e.g. the beam that is used), resources in the power domain (e.g. transmission power), etc.

Sometimes a network access procedure needs to be performed so that data may be communicated between the UE and the TRP. For example, the UE may operate in a low-power state and only access the network when the UE has data to transmit to the TRP or the TRP has data to transmit to the UE. Network access is performed for transmission of the data. In one example, the UE and network may operate according to a radio resource control (RRC) protocol, and the UE may be in an RRC Idle state or RRC Inactive state most of the time to preserve battery life. The UE may access the network only for data transmission/reception. In an example scenario, the UE might be a low-cost low-power UE dedicated to sensing and feeding back data comprising sensing results, and so the UE might only access the network to report the sensing results or receive configuration information from the TRP. Network access may allow for the establishment of a UE identifier (ID) known by both the TRP and the UE and used for the data communication. Network access might also or instead be performed for timing synchronization, e.g. so that the UE's transmissions received at the TRP are synchronized in time with the transmissions of other UEs.

One example way to perform network access is to perform a random-access procedure. For example, the following four-step random-access procedure involves the following message exchanges: (1) the UE transmits a preamble on configured random access channel resources; (2) in response to receipt of the preamble, the TRP transmits a random access response (RAR); (3) in response to receipt of the RAR, the UE transmits an uplink transmission on a resource granted in the RAR, the uplink transmission possibly including a UE ID; and (4) in response to receipt of the uplink transmission from the UE, the TRP transmits a reply including a contention resolution message, where the contention resolution message may include the UE ID to indicate to the UE that the random-access procedure was successful for the UE.

### SUMMARY

Performing a random-access procedure adds delay for the network access or the data communications. It also causes the UE to consume more power at least because the UE needs to proactively transmit a preamble on configured time-frequency resources. The embodiments disclosed a method, apparatus, device and communication system for wireless network access and data communications using passive tag.

In some embodiments herein, a UE includes a passive tag, such as a passive radio frequency ID (RFID) tag. The tag is “passive” in that it does not have its own power source (e.g. battery) and does not consume any UE power. Instead, the passive tag is powered by RF energy of a stimulus signal. The passive tag may be used to transmit a UE ID to a TRP for use in network access and/or data communication. For example, a TRP transmits a stimulus signal. The RF energy of the stimulus signal causes the antenna of the passive tag to radiate power, referred to as “backscatter”. The tag harvests the energy from the stimulus signal and uses the energy to modulate the UE ID onto the backscatter, such that the backscatter carries the UE ID. The TRP receives the backscattered UE ID. The TRP may then transmit an indication of the UE ID back to the UE, e.g. for contention resolution purposes so that the UE knows that the TRP successfully received the backscattered transmission. Data communication may then possibly occur between the TRP and the UE using the UE ID. The procedure may replace a random-access procedure and may be lower power and/or have less delay compared to a random-access procedure.

In some embodiments, for data transmission between the UE and TRP to successfully occur, the UE ID needs to be transmitted from the UE to the TRP, and the UE needs to know that the TRP successfully received the transmission including the UE's ID. Therefore, in one embodiment, the passive tag backscatters the UE ID in response to a stimulus signal. Optionally, the UE may also backscatter data that the UE has to transmit to the TRP. The TRP might not successfully receive the backscattered transmission, e.g. due to interference. The TRP indicates that it has successfully received the backscattered transmission by transmitting a response that indicates the UE ID, e.g. the UE ID is included in the response. Optionally, the response might also carry data that the TRP has to transmit to the UE, and/or the response might also carry a timing advance value for timing synchronization. The UE receives the response and determines that the response indicates the UE ID. Optionally, data communication may then be performed using the UE ID, e.g. if the backscattered transmission or the response did not include data, or if there is more data to communicate between the UE and TRP.

Many different embodiments and variations of those embodiments are discussed herein. A few examples are as follows: the stimulus signal might be a sensing signal used for sensing; and/or data might be backscattered along with the UE ID; and/or the backscattered information may indicate if the UE has data to transmit to the TRP; etc.

Also, the embodiments herein are not limited to between a UE and TRP, but more generally can be implemented between any entities. The entities may be of the same type (e.g. two UEs) or of different types (e.g. a UE and a TRP). Therefore, throughout this disclosure, the term “apparatus” will be used to refer to an entity having a passive tag that performs backscattering, and the term “device” will be used to refer to an entity that transmits the stimulus signal and/or receives the backscatter. This is notation adopted simply for ease of explanation, and is not meant to be limiting. The apparatus may be a UE, TRP, or another entity, and the device may be a UE, TRP, or another entity.

In view of the above, in some embodiments there is provided a method performed by an apparatus having a passive tag. The method may include the passive tag backscattering information to a device in response to a stimulus signal. The information may include an ID associated with the apparatus. The method may further include receiving a response from the device in response to backscattering the information. The method may further include determining that the response indicates the ID. A corresponding method performed by the device may include receiving the information backscattered from the passive tag of the apparatus, the information backscattered in response to the stimulus signal, and the information including at least the ID associated with the apparatus. The method may further include in response to receiving the information, transmitting a response to the apparatus. The response may indicate the ID.

Technical benefits of some embodiments may include the following. As explained above, the backscattering of the ID followed by a response indicating the ID allows for data communication to successfully occur. Additionally, in some embodiments, the procedure may accomplish an outcome similar to or equal to network access, while avoiding a random-access procedure. The procedure using the passive tag may be faster and/or lower power compared to a random-access procedure, e.g. because there is no need for active random-access preamble transmission. Depending upon the embodiment, there may be further power savings, e.g. by backscattering an indication of whether the apparatus has data to send to the device, and only transmitting the response to the apparatus if the apparatus has data to send. In some embodiments, the backscatter and/or the response may carry data, thereby possibly reducing or avoiding the need for a separate data transmission.

Note that the term “data”, as used herein, is not meant to be limiting, e.g. it also encompasses information for configuration or control (e.g. resource configuration information), not just traffic.

Corresponding apparatus and device for performing the methods herein are also disclosed. Here, the apparatuses may be one or components of another apparatus, for example, one or more chipsets or one or more entities/means for performing the methods. Similarly, the device may be one or components of another device, for example, one or more chipsets or one or more entities/means for performing the methods.

Corresponding computer-readable medium storing instructions is disclosed, wherein when the instructions are executed by a computer, cause the computer to implement the methods above.

Corresponding computer program comprising instructions is disclosed, wherein when the instructions are executed by a computer, cause the computer to implement the methods above.

Corresponding communication system comprising the apparatus and the device is disclosed.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a device and a plurality of apparatuses, according to one embodiment;

FIG. 6 illustrates an example of a passive tag;

FIG. 7 illustrates example scenarios in which the stimulus signal is also a sensing signal;

FIG. 8 illustrates an embodiment in which a first device transmits the stimulus signal, but a different second device receives the backscatter;

FIG. 9 illustrates a method performed by a device and an apparatus, according to one embodiment; and

FIGS. 10 to 16 illustrate specific examples of FIG. 9, according to various embodiments.

### DETAILED DESCRIPTION

For illustrative purposes, specific example embodiments will now be explained in greater detail below in conjunction with the figures.

### EXAMPLE COMMUNICATION SYSTEMS AND DEVICES

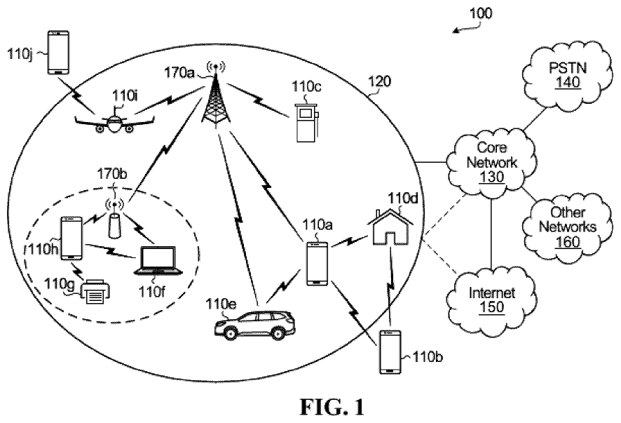

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

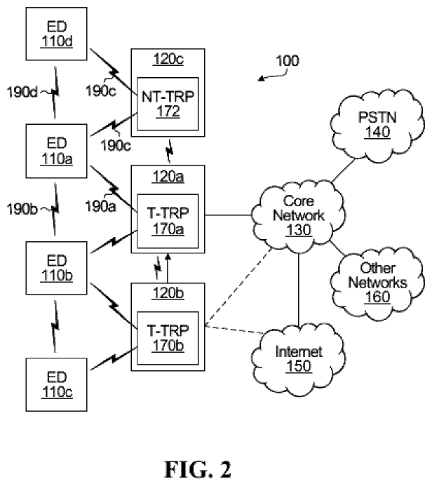

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the Eds 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of Eds and one or multiple NT-TRPs for multicast transmission.

The RANs 120a and 120b are in communication with the core network 130 to provide the Eds 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or Eds 110a 110b, and 110c or both, and (ii) other networks (such as the PSTN 140, the internet 150, and the other networks 160). In addition, some or all of the Eds 110a 110b, and 110c may include functionality for communicating with different wireless networks over different wireless links using different wireless technologies and/or protocols. Instead of wireless communication (or in addition thereto), the Eds 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). Eds 110a 110b, and 110c may be multimode devices capable of operation according to multiple radio access technologies, and incorporate multiple transceivers necessary to support such.

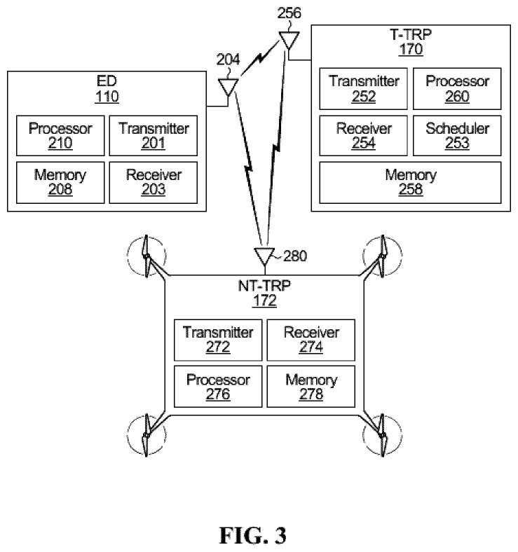

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation Eds 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

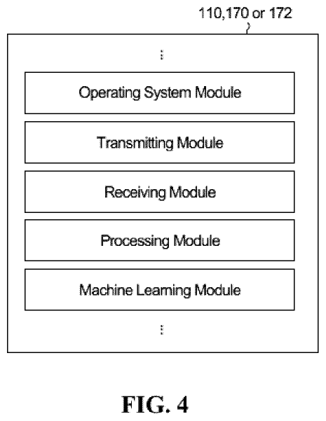

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH), a physical downlink control channel (PDCCH), or a physical sidelink shared channel (PSSCH). An example of control information that is dynamically indicated is information sent in physical layer control signaling, e.g. uplink control information (UCI) sent in a PUCCH or downlink control information (DCI) sent in a PDCCH or sidelink control information (SCI) sent in a PSSCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI, UCI, or SCI. Control information could be carried in one message or in a combination of two or more message.

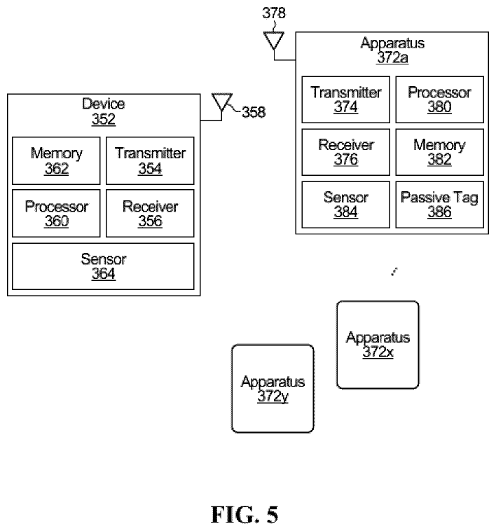

FIG. 5 illustrates a device 352 and a plurality of apparatuses 372a to 372y, according to one embodiment.

The device 352 may be a network device that is part of a network (e.g. part of RAN 120). For example, the device 352 may be a TRP, such as T-TRP 170 or NT-TRP 172. Alternatively, the device may be a UE, such as ED 110. In some embodiments, the device 352 may act as an access point to the network. In some embodiments, the parts of the device 352 may be distributed. For example, some of the modules of the device 352 may be located remote from the equipment housing the antennas and/or panels of the device 352, and may be coupled to the equipment housing the antennas/panels over a communication link (not shown). Therefore, in some embodiments, the term device 352 may also or instead refer to one or more modules (e.g. an integrated circuit) that perform processing operations, such as resource allocation (e.g. generating grants), message generation, encoding/decoding, etc., and that are not necessarily part of the equipment housing the antennas and/or panels of the device 352. The modules may also be coupled to other devices. In some embodiments, the device 352 may actually be a plurality of devices (e.g. a plurality of TRPs) that are operating together to serve the apparatuses, e.g. through coordinated multipoint transmissions.

The device 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. In some embodiments, the transmitter 354 may be implemented by a baseband processor and transmitter chain including a digital-to-analog convertor (DAC), a frequency up-convertor, and a power amplifier coupled to antenna 358. The processing components of the transmitter 354 (e.g. some or all of a baseband processor) may be implemented by processor 360. In some embodiments, the receiver 356 may be implemented by a receiver chain including the antenna 358 coupled to one or more filters, a frequency down-convertor, and an analog-to-digital convertor (ADC), and a baseband processor. The processing components of the receiver 356 (e.g. some or all of a baseband processor) may be implemented by processor 360.

The processor 360 performs (or controls the device 352 to perform) much of the operations described herein as being performed by the device 352, e.g. transmitting the stimulus signal, receiving and demodulating the backscatter, generating and transmitting a response, performing data transmission, etc. Generation of data for transmission may include arranging the data in a message format, encoding the message, modulating, performing beamforming (as necessary), etc. Processing received data transmissions may include performing beamforming (as necessary), demodulating and decoding the received messages, etc. Encoding is implemented according to a channel coding scheme, e.g. polar coding, LDPC coding, turbo coding, convolutional coding, etc. Modulating may be performed by a modulator according to a modulation scheme, e.g. quadrature amplitude modulation (QAM), amplitude modulation, pulse width modulation, etc. Demodulating may be performed by a demodulator, which may be implemented by the processor 360, possibly together with the decoder. The demodulator performs demodulation in accordance with the modulation scheme that was used for the transmission. For example, if QAM was used to modulate the signal, then demodulation may be performed using a coherent demodulator, e.g. splitting the signal and applying each to a mixer, with one half having the in-phase local oscillator applied and the other half having the quadrature oscillator signal applied. As another example, if amplitude modulation and/or pulse width modulation are implemented (e.g. in the backscattering), then demodulation may be performed by filtering out the carrier to determine the original signal amplitude and/or by converting the signal to a pulse amplitude modulation (PAM) signal and detecting the PAM signal using a low pass filter. Decoding may be performed by a decoding method that decodes according to a channel coding scheme, e.g. polar decoding if the data is encoded using a polar code, low-density parity check (LDPC) decoding algorithm for a LDPC code, etc. Example decoding methods that may be implemented include (but are not limited to): maximum likelihood (ML) decoding, and/or minimum distance decoding, and/or syndrome decoding, and/or Viterbi decoding, etc.

Although not illustrated, the processor 360 may form part of the transmitter 354 and/or receiver 356. The device 352 further includes a memory 362 for storing data.

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

In some embodiments the device 352 further includes a sensor 364. Sensor 364 is a device or module whose purpose is to perform sensing of the environment, e.g. to determine a parameter of one or more of the apparatuses 372a-y, such as distance, and/or position, and/or orientation, and/or speed, and/or location, and/or shape of the one or more apparatuses 372a-y. In some embodiments, the sensor 364 is used for radio frequency (RF) sensing, in which case the sensor 364 might be or include an antenna (which might be different from antenna 358, although not necessarily). In some embodiments, the sensor 364 may transmit a sensing signal comprising radio waves. The sensing signal reflects off of one or more of the apparatuses 372a-y. A reflection may be referred to as a reflected signal. The reflected signal may be received by the sensor 364 and processed to determine one or more parameters of one or more of the apparatuses 372a-y. In some embodiments, the following may be detected in a reflected signal received by the sensor 364: detected energy and/or amplitude and/or an angle of arrival of the reflected signal and/or time at which the reflected signal was received. In some embodiments, RADAR may be implemented by the sensor 364. In some embodiments, the sensor 364 only includes the circuitry for transmitting radio waves and/or receiving reflected radio waves, with the processor 360 controlling the transmission of the radio waves and processing any received reflected signal. As discussed in some embodiments herein, the sensing signal may also be the stimulus signal for stimulating a passive tag.

If the device 352 is T-TRP 170, then the processor 360 may be or include processor 260 and may implement scheduler 253, the memory 362 may be or include memory 258, the transmitter 354 may be or include transmitter 252, and the receiver 356 may be or include receiver 254. If the device 352 is NT-TRP 172, then the processor 360 may be or include processor 276, the memory 362 may be or include memory 278, the transmitter 354 may be or include transmitter 272, and the receiver 356 may be or include receiver 274. If the device 352 is ED 110, then the processor 360 may be or include processor 210, the memory 362 may be or include memory 208, the transmitter 354 may be or include transmitter 201, and the receiver 356 may be or include receiver 203.

FIG. 5 illustrates multiple apparatuses 372a-y, with the components of apparatus 372a shown in more detail. The reference numeral 372 will be used herein to designate a single apparatus more generically.

Each apparatus 372 includes a transmitter 374 and receiver 376, which may be integrated as a transceiver. The transmitter 374 and receiver 376 are coupled to one or more antennas 378. Only one antenna 378 is illustrated. One, some, or all of the antennas may alternatively be panels. In some embodiments, the transmitter 374 may be implemented by a baseband processor and transmitter chain including a DAC, a frequency up-convertor, and a power amplifier coupled to antenna 378. The processing components of the transmitter 374 (e.g. some or all of a baseband processor) may be implemented by processor 380. In some embodiments, the receiver 376 may be implemented by a receiver chain including the antenna 378 coupled to one or more filters, a frequency down-convertor, and an ADC, and a baseband processor. The processing components of the receiver 376 (e.g. some or all of a baseband processor) may be implemented by processor 380.

In some embodiments, the parts of the apparatus 372 may be distributed. For example, some of the modules of the apparatus 372 may be located remote from the equipment housing the antennas and/or panels of the apparatus 372, and may be coupled to the equipment housing the antennas/panels over a communication link (not shown). Therefore, in some embodiments, the term apparatus 372 may also or instead refer to one or more modules (e.g. an integrated circuit) that perform processing operations, and that are not necessarily part of the equipment housing the antennas and/or panels of the apparatus 372.

The processor 380 performs (or controls the apparatus 372 to perform) much of the operations described herein as being performed by the apparatus 372, e.g. backscattering an ID, receiving a response to the backscattering, performing data transmission, etc. Generation of data for transmission may include arranging the data in a message format, encoding the message, modulating, performing beamforming (as necessary), etc. Processing received data transmissions may include performing beamforming (as necessary), demodulating and decoding the received messages, etc. Encoding is implemented according to a channel coding scheme, e.g. polar coding, LDPC coding, turbo coding, convolutional coding, etc. Modulating may be performed by a modulator according to a modulation scheme, e.g. QAM. Demodulating may be performed by a demodulator that performs demodulation in accordance with the modulation scheme that was used for the transmission. For example, if QAM was used to modulate the signal, then demodulation may be performed using a coherent demodulator, e.g. splitting the signal and applying each to a mixer, with one half having the in-phase local oscillator applied and the other half having the quadrature oscillator signal applied. Decoding may be performed by a decoding method that decodes according to a channel coding scheme, e.g. polar decoding if the data is encoded using a polar code, LDPC decoding algorithm for a LDPC code, etc. Example decoding methods that may be implemented include (but are not limited to): ML decoding, and/or minimum distance decoding, and/or syndrome decoding, and/or Viterbi decoding, etc.

Although not illustrated, the processor 380 may form part of the transmitter 374 and/or receiver 376. The apparatus 372 further includes a memory 382 for storing data.

The processor 380 and processing components of the transmitter 374 and receiver 376 may be implemented by the same or different one or more processors that are configured to execute instructions stored in a memory (e.g. in memory 382). Alternatively, some or all of the processor 380 and/or processing components of the transmitter 374 and/or receiver 376 may be implemented using dedicated circuitry, such as a programmed FPGA, a GPU, or an ASIC.

In some embodiments the apparatus 372 further includes a sensor 384. Sensor 384 is a device or module whose purpose is to perform sensing of the environment. The implementation of the sensor 384 is application-specific and depends upon the object and/or condition being sensed. In some embodiments, the sensor 384 may perform RF sensing, e.g. through the transmission of a sensing signal comprising radio waves and processing of a reflected signal, as explained above in relation to sensor 364. In some embodiments, the sensor 384 might also or instead sense an environmental parameter, e.g. the sensor 384 might be or include a tactile sensor, or a strain sensor, or a humidity sensor, or a camera sensor (to take a digital image), etc. In some embodiments, data is generated by the sensing performed by sensor 384, and the apparatus 372 needs to periodically transmit the data to the device 352, which may be implemented via any of the embodiments explained herein.

If the apparatus 372 is T-TRP 170, then the processor 380 may be or include processor 260 and may implement scheduler 253, the memory 382 may be or include memory 258, the transmitter 374 may be or include transmitter 252, and the receiver 376 may be or include receiver 254. If the apparatus 372 is NT-TRP 172, then the processor 380 may be or include processor 276, the memory 382 may be or include memory 278, the transmitter 374 may be or include transmitter 272, and the receiver 376 may be or include receiver 274. If the apparatus 372 is ED 110, then the processor 380 may be or include processor 210, the memory 382 may be or include memory 208, the transmitter 374 may be or include transmitter 201, and the receiver 376 may be or include receiver 203.

The apparatus 372 further includes a passive tag 386, which is used for backscattering at least an ID associated with the apparatus 372. The passive tag 386 is “passive” in that it does not have its own power source (e.g. battery) and does not consume any power from the apparatus 372. Instead, the passive tag 386 is powered only by RF energy of a stimulus signal. The stimulus signal may alternatively be called an “RF stimulus signal” or a “stimulus signal carrying RF energy”. Examples of passive tag 386 include: a passive RFID tag; or a passive near-field communication (NFC) tag; or a passive WiFi tag; or a passive long range radio (LoRa) tag; or a passive Bluetooth tag; or a passive tag based on 5G new radio (NR); or a passive tag based on next generation (e.g., 6G or later) RAN.

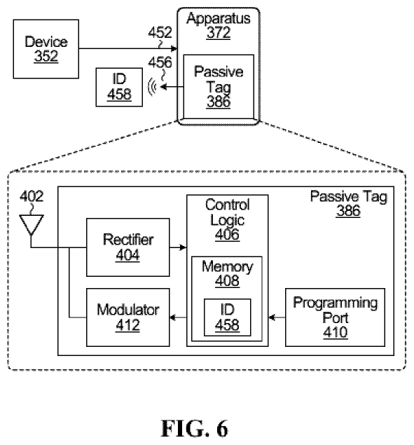

FIG. 6 illustrates an example of passive tag 386 implemented as a passive RFID tag. The passive tag 386 includes an antenna 402. For example, the antenna 402 may be a half-wave dipole antenna. In general, the antenna 402 is separate from and in addition to antenna 378, although they could possibly be the same antenna. The passive tag 386 further includes a rectifier 404 to rectify received RF energy into DC power. The rectifier 404 may be implemented by one or more diodes. The passive tag 386 further includes control logic 406 for controlling the operations of the passive tag 386, e.g. for causing backscattering of an ID. The control logic 406 may include memory 408, or the memory 408 may be separate from the control logic 408. The memory 408 may store the bits to be backscattered, e.g. including at least an ID 458 associated with the apparatus 372. The passive tag 386 may further include a programming port 410 interfacing with the rest of the apparatus 372, e.g. allowing the apparatus 372 to configure the passive tag 386 and write to memory 408. The passive tag 386 further includes a modulator 412 to encode bits stored in memory 408 (including at least the ID 458) onto the backscattered signal. The modulator 412 may be implemented by a transistor that is turned on and off based on the bits to be encoded. The transistor may be used to short a feed point of the antenna 402.

In one embodiment, in operation the device 352 transmits a stimulus signal 452 in the form of radio waves carrying RF energy. The stimulus signal 452 reaches the antenna 402 and the rectifier 404 rectifies the RF energy of the stimulus signal 452 into DC power to power up the control logic 406. The stimulus signal 452 causes the antenna 402 to radiate power, referred to as backscatter 456. The control logic 406 controls when the backscatter 456 occurs. The control logic 406 controls the modulator 412 to encode the ID 458 (and possibly other data stored in the memory 408) onto the backscatter 456. For example, the modulator 412 may comprise a transistor that is turned on and off based on the bits, e.g. when a bit is “high” (e.g. ‘1’) then there is maximum backscatter, and when a bit is “low” (e.g. ‘0’) then there is minimum backscatter. The modulation may therefore be amplitude modulation and/or pulse width modulation. The apparatus 372 may use programming port 410 to write data to memory 408, e.g. data that is for transmission to the device 352 and is to be backscattered by the passive tag 386. The apparatus 372 may also configure the control logic 406 of the passive tag 386 through the programming port 410, e.g. configure when the backscattering of the bits is to occur. For example, the control logic 406 of the passive tag 386 may be configured by the apparatus 372 to not perform backscattering initially (or to perform backscattering but not encoded/modulated with bits), and then at a certain time backscatter the bits of ID 458.

In another example, the passive tag 386 may generally comprise three components: an energy harvesting module (e.g. such as including rectifier 404), a backscatter module (e.g. such as including modulator 412 and antenna 402), and a low-power signal processing module (e.g. such as including control logic 406).

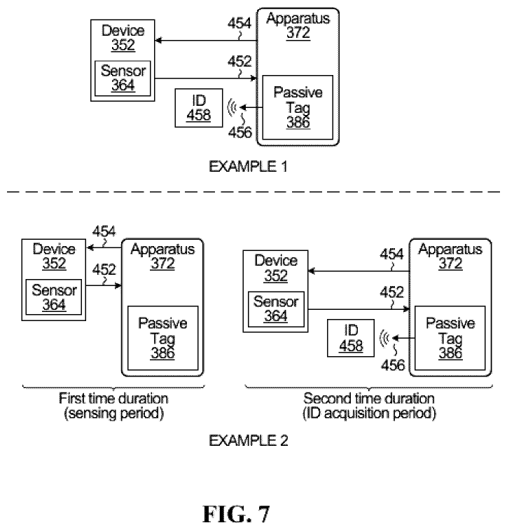

In some embodiments, the stimulus signal transmitted by the device 352 may be a sensing signal, e.g. a signal that is also used by sensor 364 to perform sensing. Some example scenarios in which the stimulus signal is also a sensing signal are illustrated in FIG. 7. In Example 1, the stimulus signal 452 is a sensing signal that reflects off of the apparatus 372. The reflection is referred to as reflected signal 454. The reflected signal 454 is received by sensor 364 on the device 352 and analysed to determine at least one parameter of the apparatus 372. Example parameters of the apparatus 372 that may be determined by the reflected signal 454 include: distance, and/or position, and/or orientation, and/or speed, and/or location, and/or shape of the apparatus 372. The stimulus signal 452 also stimulates the passive tag 386 of the apparatus 372 to cause the passive tag 386 to backscatter 456 at least the ID 458 associated with the apparatus 372. The device 352 receives the backscattered ID 458.

In Example 2 of FIG. 7, the stimulus signal 452 is a sensing signal that is transmitted for a duration of time encompassing both a first time duration (referred to as a “sensing period”) and a second time duration (referred to as a “ID acquisition period”). The sensing period may immediately precede the ID acquisition period. During the sensing period, the passive tag 386 is configured by the apparatus 372 to not perform backscattering, or alternatively to perform backscattering but not backscatter the ID 458. The device 352 receives the reflected signal 454 and can process the reflected signal 454 to detect at least one parameter of the apparatus 372, without trying to also detect the backscattered ID 458. During the subsequent ID acquisition period, the passive tag 386 is configured by the apparatus 372 to backscatter 456 the ID 458, and the device 352 focuses on detecting the ID 458, possibly ignoring any reflected signal 454 that may be present.

When the stimulus signal 452 is a sensing signal, like in FIG. 7, the stimulus signal 452 may be any signal that is used for sensing in a sensing system and that also stimulates a passive tag. Examples include (but not limited to): a synchronization signal (SS) and/or a SS block (SSB) and/or a pilot and/or a reference signal (RS) and/or a signal carried in a PDSCH or sensing channel. The sensing signal may be carried by any communication waveform such as Orthogonal Frequency Division Multiplexing (OFDM), Discrete Fourier Transform spreading OFDM (DFT-s-OFDM) or other types of multi-carrier or single carrier waveforms, or any sensing waveform such as Frequency Modulated Continuous Wave (FMCW) or Chirp.

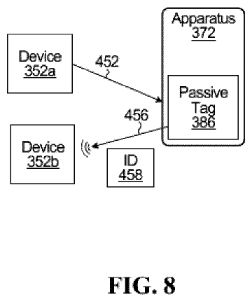

The examples above thus far assume that the device 352 both transmits the stimulus signal 452 and receives the backscatter 456 carrying the ID 458. FIG. 8 illustrates an alternative embodiment in which a first device 352a transmits the stimulus signal 452, but a different second device 352b receives the backscatter 456 carrying the ID 458. Therefore, more generally, the device that receives the backscatter and/or reflected signal does not need to be the device that transmits the stimulus signal. If the stimulus signal 452 is also a sensing signal, then the sensing in FIG. 7 may be referred to as monostatic sensing because the same device transmits and receives the sensing signal. Any sensing in FIG. 8 may be referred to as bistatic sensing if the second device 352b receives the reflected signal that is a reflection of the sensing signal transmitted by the first device 352a.

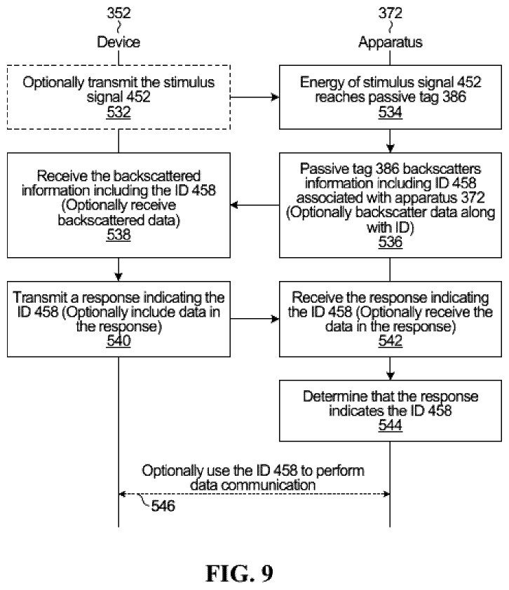

FIG. 9 illustrates a method performed by device 352 and apparatus 372, according to one embodiment. At step 532, the device 352 transmits a stimulus signal 452 towards the apparatus 372. Step 532 is optional because the stimulus signal 452 might have instead been transmitted by another device, e.g. like in the scenario described above in relation to FIG. 8.

The energy of the stimulus signal 452 reaches the passive tag 386 of the apparatus 372, as indicated in box 534. Box 534 is not a step performed by the apparatus 372 per se, but it is a requirement for subsequent step 536. For example, if the apparatus 372 were outside the range of the stimulus signal 452, the passive tag 386 could not backscatter.

At step 536, the passive tag 386 of the apparatus 372 backscatters information in response to the stimulus signal 452. The information includes ID 458 associated with the apparatus 372. The backscattering may be performed in the manner described above, e.g. the RF energy of the stimulus signal 452 powers the passive tag 386 including control logic that controls a modulator to encode the ID 458 onto backscatter at the configured time. Optionally, data that the apparatus 372 has to send to the device 352 may also be backscattered along with the ID 458. Optionally, to improve the reliability of the following transmissions, beam information (e.g. such as SSB index) may be backscattered along with the ID 458. For example, this may let the device 352 know which beam direction is better to transmit/receive data to/from the apparatus 372. The beam information may be part of the data.

At step 538, the information backscattered from the passive tag 386, including the ID 458, is received at the device 352, e.g. by the device 352 demodulating the bits of the ID 458 that are modulated on the backscattered signal. Optionally, backscattered data is also received if it was transmitted in step 536.

At step 540, in response to receiving the backscattered information, the device 352 transmits a response to the apparatus 372. The response indicates the ID 458 that was received in the backscattered information. Optionally, the response may include data that the device 352 has to send to the apparatus 372. Optionally, the response may include a timing advance (TA) value. The TA value may be part of the data.

At step 542, the apparatus 372 receives the response, and at step 544 the apparatus 372 determines that the response indicates the ID 458.

Optionally, at step 546, subsequent to the device 352 transmitting the response and subsequent to the apparatus 372 determining that the response indicates the ID 458, the ID 458 may be used by the device 352 and the apparatus 372 to perform data communication.

By performing the method of FIG. 9, the apparatus 372 can transmit, to the device 352, an ID 458 associated with the apparatus 372 (i.e. ID 458 of FIG. 9). This may be done without the apparatus 372 using apparatus 372 power/battery because the transmission of the ID 458 occurs using backscattering, thereby providing power savings for the apparatus 372, which may be important if the apparatus 372 is a low-power device. Moreover, because the device 352 is not guaranteed to receive the backscattered transmission, e.g. because of interference, the apparatus 372 can confirm that the device 352 successfully received the backscattered transmission by determining in step 544 that the response indicates the ID 458. Data communication between the apparatus 352 and 372 may be successfully performed. For example, if data was backscattered by the apparatus 372 along with the ID 458 in step 536, the apparatus 372 knows that the device 352 successfully received that data, and the apparatus 372 knows that the device 352 can associate the data as being from that apparatus 372, because the apparatus 372 has determined in step 544 that the response indicates the ID 458 associated with the apparatus 372. As another example, if data was sent to apparatus 372 in the response received by the apparatus 372 in step 542, the apparatus 372 knows that the data is from the device 352 and is specifically for that apparatus 372 because the apparatus 372 has determined in step 544 that the response indicates the ID 458 associated with the apparatus 372. As another example, after step 544 (at step 546), the apparatus 372 and device 352 may perform data communication because the device 352 knows the ID 458 associated with the apparatus 372, and the apparatus 372 has confirmed via step 544 that the device 352 does indeed know the ID 458 associated with the apparatus 372. The ID 458 is used for performing the data communication, e.g. for scrambling control information that schedules a data transmission (e.g. the control information indicates a time-frequency location for sending or receiving data, where that control information is scrambled using the ID 458, e.g. the CRC of the control information is scrambled using the ID 458).

In view of the above, in some embodiments, the method of FIG. 9 may include the apparatus 372 and the device 352 performing data communication with each other. This may occur in at least one of the following ways: (1) the apparatus 372 backscatters data along with the ID at step 536, and the backscattered data is received by the device 352 along with the ID at step 538; and/or (2) the device 352 transmits data to the apparatus 372 in the response at step 540 and the data is received by the apparatus 372 in the response at step 542; and/or (3) the apparatus 372 and the device 352 use the ID 458 to perform data communication subsequent to step 544, i.e. subsequent to the response being transmitted by the device 352 at step 540 and subsequent to determining that the response indicates the ID 458 at step 544.

In embodiments in which the ID 458 is used to perform data communication subsequent to step 544 (i.e. when optional step 546 is performed), one way in which data communication may be performed is as follows. The device 352 transmits control information scrambled using the ID 458, where the control information includes an indication of a time-frequency location for transmitting or receiving data. The control information may be scrambled by scrambling a cyclic redundancy check (CRC) value of the control information, e.g. by performing an exclusive OR (XOR) of the CRC value and the ID 458. If the device 352 is a TRP and the apparatus 372 is a UE, the control information may be DCI. If the device 352 and apparatus 372 are both UEs, the control information may be SCI. Other types of control information may be implemented in different scenarios. The apparatus 372 receives the control information scrambled by the ID 458. The apparatus 372 may decode the control information and use its ID 458 to unscramble the control information, e.g. to unscramble the received CRC value of the control information by performing an XOR between the received CRC value and its ID 458. The apparatus 372 may then perform a CRC check, and determine that the control information is successfully decoded and meant for the apparatus 372 upon a valid CRC check. Performing the CRC check may include computing the CRC value using the received decoded control information and checking whether the computed CRC value equals the received unscrambled CRC value. The CRC check “passes” or is “valid” when the computed CRC value equals the received unscrambled CRC value. The apparatus 372 may then obtain, from the control information, the indication of the time-frequency location for transmitting or receiving the data. The apparatus 372 may then subsequently transmit or receive the data at that time-frequency location. Similarly, after the device 352 transmits the control information, the device 352 may subsequently transmit or receive the data at the time-frequency location. The type of data that may be communicated between the device 352 and the apparatus 372 in FIG. 9 is implementation specific, e.g. it may include (but is not limited to): user plane data, and/or measurement/sensing results/reports, and/or control information, and/or source data/gradients/parameters of an AI/machine learning model, etc. In one example, the data includes configuration or reconfiguration information that the device 352 needs to send to the apparatus 372. In another example, the data includes sensing/measurement results that the apparatus 372 needs to send to the device 352, e.g. if the apparatus is a moving wireless sensor.

In some embodiments of the method of FIG. 9, the stimulus signal 452 is a sensing signal, e.g. as explained above in relation to FIG. 7. The sensing signal is to be reflected off of the apparatus 372. The method of FIG. 9 may include the device 352 receiving a reflected signal 454 that is a reflection of the sensing signal off of the apparatus 372, and the device 352 determining a parameter of the apparatus 372 using the reflected signal. As mentioned earlier, example parameters of the apparatus 372 that may be determined using the reflected signal 454 include: distance, and/or position, and/or orientation, and/or speed, and/or location, and/or shape of the apparatus 372.

In some embodiments of the method of FIG. 9, the apparatus 372 may receive a message configuring a time duration during which the passive tag is to perform backscattering of the information including the ID, i.e. the time duration during which the apparatus 372 is to perform step 536. The message configuring the time duration may be transmitted by the device 352 or instead by another device (e.g. a network device such as a TRP) that is configuring the device 352 and/or apparatus 372. Upon receiving the message, the apparatus 372 may configure its passive tag 386 to only perform the backscattering of the information including the ID during the time duration. For example, assuming the passive tag 386 example implementation of FIG. 6, the apparatus 372 may configure the control logic 406 of the passive tag 386 through the programming port 410. When the stimulus signal 452 is received at the passive tag 386, the RF energy is harvested to power the control logic 406. The control logic 406 determines when the time duration is to begin, and at that time the control logic 406 controls the modulator 412 to modulate the ID 454 onto the backscatter. Prior to the time duration (and possibly also subsequent to the time duration), when the RF energy of the stimulus signal 452 is present, the control logic 406 may control the passive tag 386 to not perform or minimize backscatter, e.g. by setting a transistor of the modulator 412 to a position that minimizes backscatter. Alternatively, prior to the time duration (and possibly also subsequent to the time duration), when the RF energy of the stimulus signal 452 is present, the control logic 406 may control the passive tag 386 to perform backscatter, but not modulate the ID 454 or any other bits onto the backscatter. That is, in response to the stimulus signal 452, the passive tag 386 may perform backscattering without backscattering the information. In embodiments in which the apparatus 372 has other information or data to backscatter along with the ID 458, the passive tag 358 may backscatter that other information or data along with the ID 458 during the configured time duration. In some embodiments, the configured time duration is the “second time duration” (i.e. “ID acquisition period”) referred to in Example 2 of FIG. 7.

In some embodiments in which the stimulus signal 452 is a sensing signal, there may be a period of time for sensing that is prior to the configured time duration for backscattering the ID 458. An example is the “first time duration” (i.e. “sensing period”) referred to in Example 2 of FIG. 7. During the time period for sensing, the stimulus signal 452 is to be reflected off of the apparatus 372. The reflection of the sensing signal is the reflected signal 454. The reflected signal 454 is received by the device 352, and a parameter of the apparatus 372 may be determined using the reflected signal 454.

In some embodiments, different apparatuses 372a-y may be configured to have different time durations for performing backscattering of their ID. The different time durations may be partially or fully non-overlapping to reduce or minimize interference. For example, the “second time duration” (i.e. the “ID acquisition period”) in Example 2 of FIG. 7 may be at different times for different apparatuses 372a-y. In one example, a stimulus signal 452 is transmitted between time t₁ and time tₖ. Between time t₁ and t₂ apparatus 372a is configured to backscatter its ID, between time t₂ to t₃, apparatus 372b is configured to backscatter its ID, . . . , and between time tₖ₋₁ and tₖ apparatus 372y is configured to backscatter its ID. When each apparatus is not configured to backscatter its ID, it may perform no backscattering or have a uniform backscatter (i.e. with no bits modulated onto it). In this way, multiple apparatuses will not try to backscatter their ID at the same time, thereby reducing interference. In another example, a stimulus signal 452 is transmitted between time t₁ and time tₖ. Between time t₁ and t₂, no apparatus backscatters an ID, and device 352 attempts to detect a parameter of apparatus 372a (e.g. location, orientation, and/or speed, etc.) using a reflection of the stimulus signal off of apparatus 372a. Between time t₂ and t₃, only apparatus 372a backscatters its ID. Between time t₃ and t₄, no apparatus backscatters an ID, and device 352 attempts to detect a parameter of apparatus 372b (e.g. location, orientation, and/or speed, etc.) using a reflection of the stimulus signal off of apparatus 372b. Between time t₄ and t₅, only apparatus 372b backscatters its ID. This continues for each apparatus. In this way, for each apparatus there is a dedicated sensing period (e.g. “first time duration” in Example 2 of FIG. 7) and a dedicated ID acquisition period (e.g. “second time duration” in Example 2 of FIG. 7). Interference may thereby possibly be mitigated.

At steps 540 and 542 of FIG. 9, the response indicates the ID 458 associated with the apparatus 372. The ID 458 was received by the device 352 at step 538, and at step 540 the device 352 indicates that ID 458 to the apparatus 372 in the response. Some example ways in which the response indicates the ID 458 are as follows. In one example, the response transmitted in step 540 and received in step 542 is control information that is scrambled using the ID 458. For example, a CRC value of the control information may be scrambled by the device 352 using the ID 458, e.g. by performing XOR of the CRC value and the ID 458. If the device 352 is a TRP and the apparatus 372 is a UE, the control information may be DCI. If the device 352 and apparatus 372 are both UEs, the control information may be SCI. Other types of control information may be implemented in different scenarios. The response indicates the ID 458 by scrambling the control information using the ID 458. The apparatus 372 may receive the response in step 542 by receiving the control information scrambled by the ID 458. The apparatus 372 may use its ID 458 to unscramble the control information, e.g. to unscramble the received CRC value of the control information by performing an XOR of its ID 458 and the received CRC value. The apparatus 372 may then perform a CRC check using the unscrambled CRC value. The CRC check may be performed by the apparatus 372 computing a CRC value using the received decoded control information, and comparing that computed CRC value to the received descrambled CRC value. If the CRC check passes, the apparatus 372 knows that the control information was scrambled by the ID 458, which means to the apparatus 372 that the device 352 successfully received the ID 458. In this example, step 544 of FIG. 9 includes performing the previously-described steps of the apparatus 372 descrambling the control information using its ID 458 and performing a CRC check that passes. By determining that the CRC check passes, the apparatus 372 determines that the response indicates the ID 458. In this example, the control information of the response may schedule a data transmission between the device 352 and the apparatus 372, and/or the control information may include data or other information (e.g. a timing advance value and/or resource configuration information) that the device 352 wants to transmit to the apparatus 372. It could also be the case that the control information includes the ID 458 and/or schedules a transmission of the ID 458.

In another example, the response in steps 540 and 542 indicates the ID 458 by including the ID 458 in the response itself. For example, device 352 may transmit control information that either directly includes the response (having the ID 458), or the control information may indicate a time-frequency location of the response, e.g. if the control information is a scheduling grant scheduling the response. If the control information indicates the time-frequency location of the response, then the device 352 transmits the response (having the ID 458) at that time-frequency location, and the apparatus 372 receives the response at that time-frequency location. If the device 352 is a TRP and the apparatus 372 is a UE, the control information may be DCI. If the device 352 and apparatus 372 are both UEs, the control information may be SCI. Other types of control information may be implemented in different scenarios. The control information may be scrambled using a predefined identifier. The predefined identifier may be a group identifier (“group-ID”) that is shared by a plurality of apparatuses including apparatus 372. For example, each of the plurality of apparatuses may have a respective different passive tag that backscatters the ID of that apparatus in response to the stimulus signal 452. As described earlier, each apparatus may be configured to backscatter their ID at a respective different configured time to reduce interference. After an apparatus backscatters its ID, it may decode subsequent control information to see if that control information includes its ID or schedules a transmission including its ID. The control information may be scrambled by a group-ID that is known by each of the apparatuses, e.g. a CRC value of the control information may be scrambled by the group-ID. The apparatus may decode the control information and use the known group-ID to descramble the control information. If the CRC check passes, the apparatus knows it is valid control information. The apparatus may check the control information directly or a time-frequency location scheduled by the control information to obtain the response and check if the ID in the response belongs to the apparatus. If it does, then the apparatus knows the ID was successfully received by the device 352, i.e. FIG. 9 step 544 has been successfully performed. Otherwise, if the apparatus obtains an ID from the response that does not belong to it, the apparatus may try other received control information, until the apparatus either receives a response with its ID or determines that the device 352 did not successfully receive its ID. The group-ID used to scramble the control information is known by the group of apparatuses so that they can all unscramble the control information and look for a response with their ID. In one implementation, the group-ID is a radio network temporary ID (RNTI), such as a group-RNTI. In some embodiments, the group-ID may be configured in advance for the apparatuses. In some embodiments, the group-ID may be derived from the stimulus signal 452 itself. That is, when the stimulus signal 452 is received in the vicinity of an apparatus, not only does that cause the passive tag to backscatter, but it also causes the apparatus to derive a group-ID from the stimulus signal 452, e.g. based on a parameter or property of the stimulus signal 452 (e.g. based on the stimulus signal sequence) and/or based on a time and/or frequency location at which the stimulus signal 452 is received.

In some embodiments of the method of FIG. 9, the device 352 may compute a timing advance (TA) value for the apparatus 372 to be used for timing synchronization. The device 352 may compute the TA value based on a round-trip time (RTT) between the device 352 and the apparatus 372. In one example, the RTT is computed by the device 352 as the time between when the stimulus signal 452 is transmitted from the device 352 to when it is received again back at the device 352 (after reflecting off of the apparatus 372). In another example, the RTT is computed by the device 352 as the time between when the stimulus signal 452 is transmitted from the device 352 to when the backscatter from the apparatus 372 is received. In some embodiments, the response transmitted in step 540 and received in step 542 includes the TA value for the apparatus 372, where the TA value may be computed from at least one of: a reflected signal 454 that is reflection of the stimulus signal 452 off of the apparatus 372, or a backscatter 456 caused by the stimulus signal 452. In some embodiments, if there is a sensing period before the ID is backscattered (e.g. if there exists the “first time duration” in Example 2 of FIG. 7), this may allow for the device 352 to more easily compute the TA value, e.g. based on a reflection of the sensing signal off of the apparatus 372 or based on immediate backscatter without the ID 458 being backscattered. Alternatively, the TA value may be determined using the backscattered ID 458, but it might be hard to determine the RTT if the passive tag 386 is not configured to backscatter the ID 458 as soon as the stimulus signal 452 powers the passive tag 386.

In some embodiments of the method of FIG. 9, the information backscattered at step 536 and received at step 538 may additionally include an indication that the apparatus 372 has data to transmit to the device 352. The indication will be referred to as an “access request” or alternatively a “data transmission request”. In one example, the access request may be in the form of a scheduling request (SR) and/or a buffer status report (BSR). In some implementations, steps 540, 542, 544, and 546 may then only be performed if the access request is present in the backscatter, i.e. if the apparatus has data to transmit to the device 352. This may offer power savings by the elimination of steps if there is no data for the apparatus 372 to transmit to the device 352. For example, the device 352 may receive a backscattered ID from multiple apparatuses, but only complete the method of FIG. 9 for any apparatus that also includes an access request in their backscattered information.

In the method of FIG. 9, the ID 458 may be any type of ID information that can be used to identify the apparatus 372, e.g., a radio network temporary identifier (RNTI) and/or a temporary mobile subscriber identity (TMSI). In some embodiments of the method of FIG. 9, in addition to the response indicating the ID 458, the response may also include another identifier allocated by the network (e.g. by the device 352) for data communication. This may happen in the situation that the ID 458 is not an RNTI, and the device 352 needs to allocate temporarily an RNTI to the apparatus 372 after receiving the ID 458. In this case, the ID 458 indicated in the response is for the apparatus 372 to determine the response is for it, and the allocated identifier (e.g. temporary RNTI) is for the apparatus 372 to perform subsequent data communication with the device 372. In this situation, if optional step 546 is performed, the step may include using the allocated identifier (e.g. temporary RNTI) instead of the ID 458 to perform data communication, e.g. by scrambling control information scheduling a data transmission with the allocated identifier.

Although not illustrated in FIG. 9, prior to step 532 the method may include the device 352 and/or the apparatus 372 receiving resource configuration information, e.g. to configure: a time and/or frequency resource of the stimulus signal 452; and/or the stimulus signal generation information (e.g., root sequence, cyclic shift, scrambling identity, etc.) in case the stimulus signal is a sequence; and/or the time period (e.g., the starting and/or ending time of the period) for the apparatus 372 to receive the stimulus signal (e.g. the sensing period); and/or the time period (e.g., the starting and/or ending time of the period) for the apparatus 372 to backscatter ID 458 (e.g. the ID acquisition period); and/or the time period (e.g., the starting and/or ending time of the period) for the apparatus 372 to perform data communication with the device 352 (e.g. the data transmission period).

Some specific examples of FIG. 9 will now be provided below. In all of the examples below, the stimulus signal 452 is also a sensing signal, and is therefore referred to as “sensing signal” rather than “stimulus signal”.

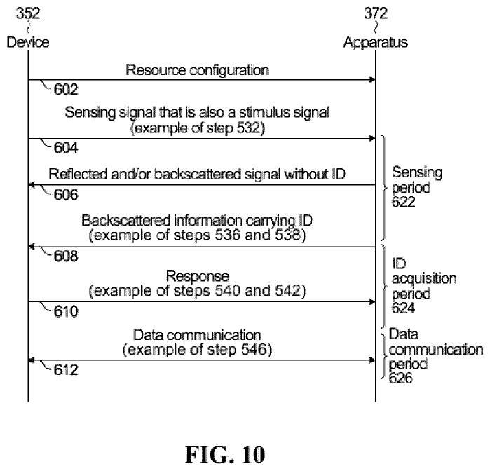

FIG. 10 illustrates a first example in which there is data communication after ID exchange, i.e. the data communication occurs at the end of the method (step 546 of FIG. 9). The method may be referred to as “data transmission after passive random access”, where “passive random access” is referring to the ID exchange (steps 536 to 544 of FIG. 9) using the passive tag, rather than the random-access procedure referred to earlier in the “Background” section of this patent application. The device 352 both transmits the sensing signal and performs the sensing, and so the sensing may be referred to as monostatic. The device 352 is assumed to be a TRP, and the apparatus 372 is assumed to be a terminal device, such as a UE. In view of the foregoing, the method of FIG. 10 may be referred to as “a low-power data transmission method (data transmission after passive random access) after sensing in monostatic sensing system between network device and terminal device with assistant of a passive tag”. The steps of the method of FIG. 10 are as follows.

Step 602: The device 352 sends resource configuration information to the apparatus 372. The resource configuration information is used to configure the apparatus 372 to receive the sensing signal, e.g. to configure the time and/or frequency resources of the sensing signal, the generation information (e.g., root sequence, cyclic shift, scrambling identity, etc.) of the sensing signal in case the sensing signal is a sequence, etc. The resource configuration information is also used to configure the time periods (e.g., the starting and/or ending time of the periods) for the apparatus 372 to receive the sensing signal, backscatter the ID 458 of the apparatus 372, and perform data communication with the device 352. That is, the resource configuration information configures a sensing period 622, an ID acquisition period 624, and a data transmission period 626. The device 352 and apparatus 372 behaviors may be different in the different configured time periods. The ID acquisition period 624 may be defined and configured to help to mitigate interference among apparatuses, e.g. by configuring the ID acquisition periods of different apparatuses to be non-overlapped. Although FIG. 10 illustrates a sensing period 622, an ID acquisition period 624, and a data transmission period 626, in some implementations the ID acquisition period 624 is configured (e.g. to try to reduce interference), but the sensing period 622 and data transmission period 626 are optionally configured. RRC signaling (e.g., system information, device-specific RRC signaling, group-specific RRC signaling), MAC CE, or DCI can be used by the device 352 to send the resource configuration information. Optionally, before sending the resource configuration information, the device 352 first receives capability information reported by the apparatus 372. The capability information indicates that the apparatus 372 supports the method of FIG. 10, i.e. has the passive tag and can perform the steps of FIG. 10.

Step 604 (Example of step 532 of FIG. 9): The device 352 transmits the sensing signal to the apparatus 372. The sensing signal can be any signal that is used for sensing in a sensing system, including but not limited to: a synchronization signal (SS)/SS block (SSB)/pilot/reference signal (RS)/signal carried in PDSCH or sensing channel. The sensing signal may be carried by any communication waveform such as Orthogonal Frequency Division Multiplexing (OFDM), Discrete Fourier Transform spreading OFDM (DFT-s-OFDM) or other types of multi-carrier or single carrier waveforms, or any sensing waveform such as Frequency Modulated Continuous Wave (FMCW) or Chirp. The sensing signal is the stimulus signal.

Step 606 (Example of “first time duration” in Example 2 of FIG. 7): A sensing period 622 is optionally configured. During the sensing period, the apparatus 372 reflects and/or backscatters the signal to the device 352. If backscattering occurs, it is without the ID 458, e.g. nothing is modulated onto the backscatter. Step 606 is optional, but if configured to be performed, it may be used for several possible purposes: (1) to obtain sensing parameters of the apparatus 372, e.g. as discussed above in relation to FIG. 7; and/or (2) to calculate timing advance (TA) information for the apparatus 372, e.g. using RTT in the manner explained earlier; and/or (3) to help to avoid the device 352 from blindly detecting the backscattered ID 458 in step 608 below. Blind detection would involve the device 352 trying to detect the backscattered ID 458 every symbol or frame because the device 352 does not know if/when it will arrive. However, this might be avoided if there is a sensing period (step 606). The receipt of a reflection or backscatter (without ID) in sensing period 622 means there is an apparatus present, so the device 352 knows that there will be a backscattered ID coming, and the backscattered ID is expected at the end of the sensing period 622. Hence, the device 352 need not perform blind detection, or at least the detection might not be as blind (e.g. the device 352 still might not know exactly when the backscattered ID is arriving because that may depend on when the apparatus 372 is configured to send it, but the device 352 at least knows one is coming within a particular time window).

Step 608 (Example of steps 536 and 538 of FIG. 9): An ID acquisition period 624 has been defined in which the apparatus 372 backscatters its ID 458 to the device 352. Optionally, to improve the reliability of the following transmissions, beam information such as SSB index can also be backscattered, e.g. to let the device 352 know which beam direction is better to transmit/receive data to/from the apparatus 372.

Step 610 (Example of steps 540 and 542 of FIG. 9): After the ID 458 of the apparatus 372 is acquired by the device 352 (by demodulating/detecting it from the backscatter), the device 352 sends a response (e.g. message) indicating the ID 458 (e.g. carrying the ID 458). This may indicate the success of the network access. In some embodiments, the response acts as a contention resolution message, e.g. to indicate to the apparatus 372 that it successfully received the ID 458 of the apparatus 372, not the ID of another apparatus that may also be backscattering its ID to the device 352. To send the response, traditional ways for data transmission in Uu link may be used, e.g. the device 352 transmits DCI scrambled by an RNTI to schedule a PDSCH carrying the response. This is an example of one method of indicating the ID 458 in the response described earlier in relation to FIG. 9 (the device 352 scrambling control information that schedules the response). The RNTI may be an example of the Group-ID referred to earlier. In some implementations, the RNTI used to scramble the DCI can be configured by the device 352 (e.g. included in the resource configuration information in step 602), or derived from the sensing signal received in step 604. For example, there may be a preconfigured/predefined mapping relation between the RNTI and the sensing signal, e.g., the RNTI has a mapping relation with the time and/or frequency and/or sequence used for the sensing signal. Optionally, the ID 458 can be used as the RNTI. Optionally, downlink data, RRC configuration (or reconfiguration) information, or other information that needs to be delivered from device 352 to the apparatus 372 can also be included in the response. Optionally, TA information obtained in 606 can also be included in the response.

Step 612 (Example of step 546 of FIG. 9): Data communication occurs between the device 352 and the apparatus 372 using the ID 458. During the data communication period 626, the device 352 sends and/or receives data to/from the apparatus 372. Traditional ways for data transmission in Uu link can be used. For example, device 352 sends a DCI scrambled by the ID 458 to schedule PDSCH for downlink data and/or PUSCH for uplink data for the apparatus 372.

In a variation of FIG. 10, both the device 352 and the apparatus 372 are terminal devices, e.g. two UEs. The method steps of FIG. 10 described above remain the same, except modified to refer to sidelink instead of downlink/uplink. For example, in step 602, some or all of the resource configuration information sent by the device 352 may be transmitted in sidelink control information (SCI) instead of DCI. As another example, in step 604, instead of the sensing signal being sent in a PDSCH, the sensing signal may be sent in a physical sidelink shared channel (PSSCH). As another example, in step 610, instead of the response being sent on the downlink, the response may be sent on the sidelink or D2D link, e.g. the device 352 sends a SCI scrambled by an RNTI (e.g. Group-ID referred to earlier) to schedule a PSSCH carrying the response. As another example, at step 612, the data communication may be performed in sidelink or D2D link, e.g. the device 352 sends a SCI scrambled by the ID 458 to schedule a transmission and/or reception of data on the PSSCH.

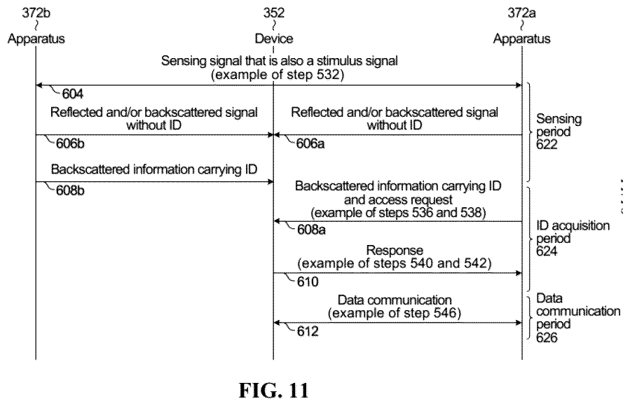

FIG. 11 illustrates a variation of FIG. 10 in which in step 604 the sensing signal is transmitted to multiple apparatuses, including apparatus 372a and apparatus 372b. In the optional sensing period 622, both apparatus 372a and apparatus 372b reflect and/or backscatter the signal (without ID 458), as shown at step 606a and 606b. During the ID acquisition period 624, both apparatus 372a and apparatus 372b backscatter their respective ID. They may be configured to backscatter their ID at respective different times to avoid interference, as shown at steps 608a and 608b. The apparatus 372a and 372b are configured to also backscatter, along with their ID, and indication as to whether the apparatus has data to send (an “access request”). In the example in FIG. 11, only apparatus 372a backscatters an access request because only apparatus 372a has data to send to the device 352. Therefore, subsequent steps 610 and 612 are only performed with apparatus 372a. The method in FIG. 11 omits the resource configuration step 602, but the step may still be present in actual implementation.

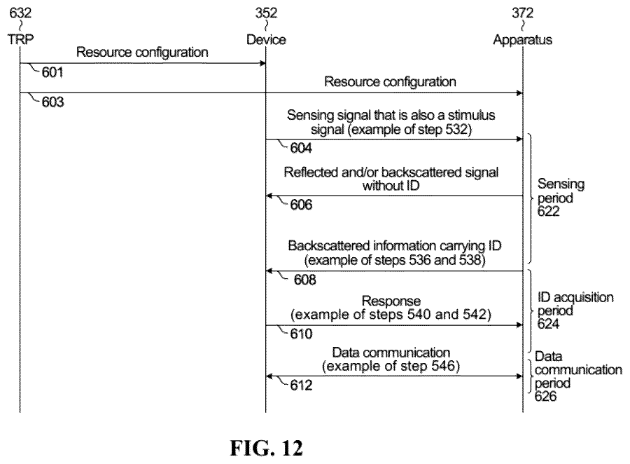

FIG. 12 illustrates a variation of FIG. 10 in which there is a TRP 632 (or other network device) helping to configure resources. Step 602 of FIG. 10 is replaced with steps 601 and 603 of FIG. 12. At step 601, device 352 receives resource configuration information sent from TRP 632, which is used to configure: the transmission configuration of the sensing signal such as time/frequency/sequence resources; and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data transmission period 626; etc. At step 603, apparatus 372 receives resource configuration information sent from TRP 632 before receiving the sensing signal. The resource configuration information is used to configure: the reception configuration of the sensing signal such as time/frequency/sequence resources; and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data transmission period 626; etc.

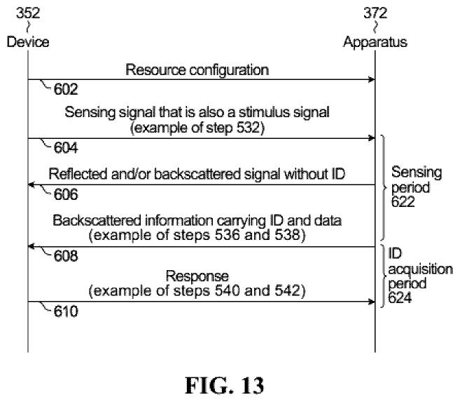

FIG. 13 illustrates a variation of FIG. 10 in which data is also backscattered from the apparatus 372 along with the ID 458 at step 608, e.g. the data may be user plane data, measurement/sensing results/reports, control information, or other information that needs to be delivered from the apparatus 372 to the device 352. Optionally, beam information may also be backscattered from the apparatus 372 to the device 352 at step 608, as described earlier in relation to FIG. 10, and if this is the case the beam information may be included as part of the data that is backscattered. Because the data is backscattered along with the ID 458, the data communication step 612 is not needed and is omitted. A data communication period 626 might not even be configured. Otherwise, all of the other description of FIG. 10 presented above still applies. Note that, like described above in relation to FIG. 10, the device 352 may be a network device (e.g. TRP) and the apparatus 372 may be a terminal device (e.g. UE), or alternatively, the device 352 and apparatus 372 may both be terminal devices (e.g. two UEs communicating over sidelink). The example in FIG. 13 may be referred to as “passive data transmission, i.e., data transmission during passive random access” because data is transmitted during the exchange of ID 458, rather than after the exchange of ID 458.

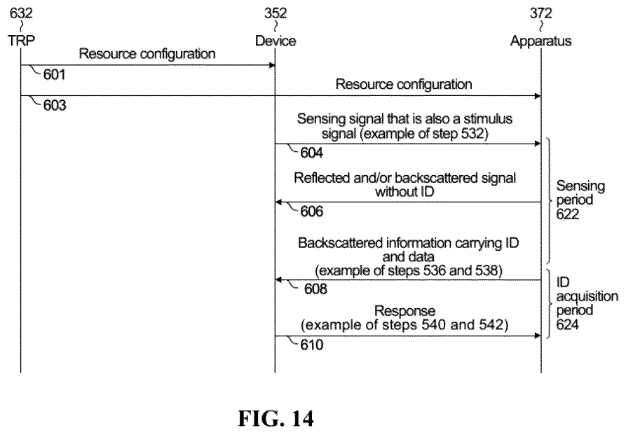

FIG. 14 illustrates a variation of FIG. 13 in which there is a TRP 632 (or other network device) helping to configure resources. Step 602 of FIG. 13 is replaced with steps 601 and 603 of FIG. 14. At step 601, device 352 receives resource configuration information sent from TRP 632, which is used to configure: the transmission configuration of the sensing signal such as time/frequency/sequence resources; and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data transmission period 626; etc. At step 603, apparatus 372 receives resource configuration information sent from TRP 632 before receiving the sensing signal. The resource configuration information is used to configure: the reception configuration of the sensing signal such as time/frequency/sequence resources; and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data transmission period 626; etc.

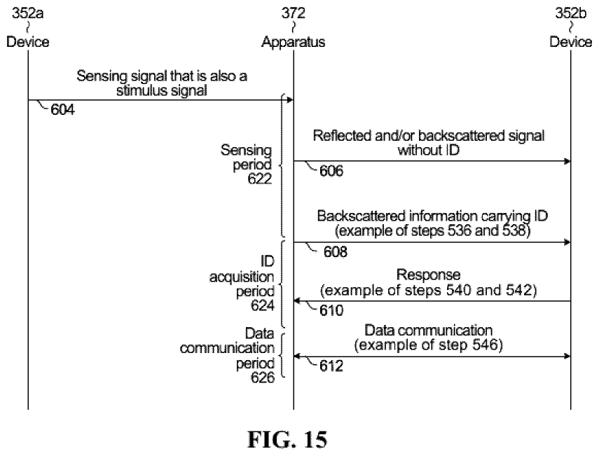

FIG. 15 illustrates a variation of FIG. 10 in which it is a bistatic sensing system, i.e. the device 352a that transmits the sensing signal (which is also a stimulus signal) is different from the device 352b that receives the reflection/backscatter and transmits the response. All of the description of FIG. 10 presented above still applies, with the following notes/caveats:
(1) Step 602 is omitted in FIG. 15, although it may be included in implementation, and possible methods for resource configuration are described below.
(2) The sensing signal transmitted in step 604 is transmitted by device 352a, but the reflection and/or backscatter (without ID 458) in step 606 is received by device 352b.
(3) Similarly, the backscattered information (including ID 458) in step 608 is to device 352b, and the response indicating the ID 458 in step 610 is from the device 352b, and the data communication in step 612 is between the apparatus 372 and the device 352b.
(4) It might not be possible to determine a TA value for the apparatus 372 from the reflected signal 454 and/or the backscatter because the device 352b receiving the reflected signal 454 and/or backscatter from the apparatus 372 is different from the device 352a that transmitted the sensing signal.

Note that device 352a and/or 352b may each be a network device (e.g. TRP) or a terminal device (e.g. UE). The apparatus 372 may be a terminal device (e.g. UE). Two terminal devices communicating with each other may do so over sidelink. For example, if device 352b and apparatus 372 are both terminal devices, then transmitted dynamic control information may be SCI instead of DCI, and transmitted data may be over a sidelink channel (e.g. PSSCH) instead of a PDSCH or PUSCH.

Although not illustrated, FIG. 15 may be modified in the same way FIG. 11 modifies FIG. 10. That is, FIG. 15 may be modified such that there are multiple apparatuses receiving the reflection and/or backscatter. Steps 610 and 612 are only completed with an apparatus that backscatters an access request along with their ID.

As mentioned above, FIG. 15 omits an initial resource configuration step (e.g. step 602). However, in actual implementation the resource configuration may be included. Three possible alternatives for resource configuration are as follows:
(1) Device 352a sends resource configuration information to both device 352b and apparatus 372 to configure resources. For example, the following may be configured for the device 352b: the reception configuration of the reflected/backscattered signal from the apparatus 372 (e.g. the time and/or frequency resources at which the signal will be received); and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data communication period 626. As another example, the following may be configured for the apparatus 372: the reception configuration of the sensing signal (e.g. the time and/or frequency resources at which the sensing signal is to be received); and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data communication period 626.
(2) Device 352b sends resource configuration information to both device 352a and apparatus 372 to configure resources. For example, the following may be configured for the device 352a: the transmission configuration of the sensing signal (e.g. the time and/or frequency resources at which the sensing signal is to be transmitted). As another example, the following may be configured for the apparatus 372: the reception configuration of the sensing signal (e.g. the time and/or frequency resources at which the sensing signal is to be received); and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data communication period 626.
(3) A different device (not illustrated), such as a TRP (or other network device) sends resource configuration information to device 352a, device 352b, and apparatus 372. For example, the following may be configured for the device 352a: the transmission configuration of the sensing signal (e.g. the time and/or frequency resources at which the sensing signal is to be transmitted). As another example, the following may be configured for the device 352b: the reception configuration of the reflected/backscattered signal from the apparatus 372 (e.g. the time and/or frequency resources at which the signal will be received); and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data communication period 626. As another example, the following may be configured for the apparatus 372: the reception configuration of the sensing signal (e.g. the time and/or frequency resources at which the sensing signal is to be received); and/or the RNTI (e.g. Group-ID) or the mapping relation between the sensing signal and the RNTI used in step 610 (to scramble control information carrying or scheduling the response); and/or the sensing period 622; and/or the ID acquisition period 624; and/or the data communication period 626.

The transmission and/or reception configuration of a sensing signal includes, for example, time and/or frequency resources of the sensing signal, the generation information (e.g., root sequence, cyclic shift, scrambling identity, etc.) in case the sensing signal is a sequence, etc. RRC signaling (e.g., system information, device-specific RRC signaling, group-specific RRC signaling), MAC CE, DCI, and/or SCI can be used to send the resource configuration information. As explained earlier in relation to FIG. 10, it may be the case that the ID acquisition period 624 is always configured to help mitigate the interference among apparatuses, e.g. by configuring the ID acquisition periods of different apparatuses to be non-overlapped. However, the sensing period 622 and the data communication period 626 may be optionally configured. Optionally, before the resource configuration described above, the apparatus 372 may need to report its capability information to device 352a or device 352b or another device (e.g. a TRP or another network device) that is responsible for resource configuration. The capability information may indicate that the apparatus 372 has a passive tag and supports the method of FIG. 15.

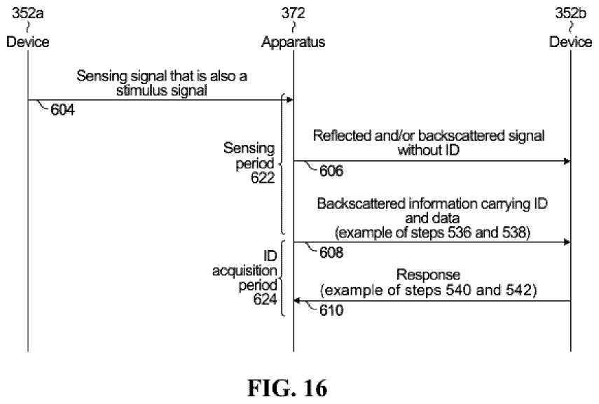

FIG. 16 illustrates a variation of FIG. 15 in which data is also backscattered along with the ID 458 at step 608, e.g. the data may be user plane data, measurement/sensing results/reports, control information, or other information that needs to be delivered from the apparatus 372 to the device 352b. Optionally, beam information may also be backscattered from the apparatus 372 to the device 352b, and if this is the case the beam information may be included as part of the data that is backscattered. Because the data is backscattered along with the ID 458, the data communication step 612 is not needed and is omitted. A data communication period 626 might not even be configured. Otherwise, all of the other description of FIG. 15 presented above still applies.

Returning to FIG. 9, as discussed above, in step 536 data may optionally be backscattered by the apparatus 372 along with the ID 458. Examples of this are also shown in FIGS. 13, 14, and 16. In some embodiments, if the apparatus 372 has data to send to the device 352, options possibly include backscatter all of the data at step 536, wait and transit the data at step 546, or some combination (e.g. backscatter some data at step 536 and transmit additional data at step 546). In some embodiments, the apparatus 372 determines whether to backscatter data along with the ID at step 536 based on at least one of the following:
(1) An amount of data to be transmitted. For example, if there is only a small amount of data to be transmitted, then the data may be backscattered, whereas if there is a large amount of data to be transmitted then the apparatus 372 may wait and transmit it via data communication performed at step 546. In one example, if the data amount exceeds a predefined/preconfigured threshold, the apparatus 372 refrains from backscattering the data in step 536 and instead transmit the data at step 546. Otherwise, the data is backscattered in step 536. When determining whether the data amount exceeds the threshold, the ID 458 might or might not be counted as part of the data, depending upon the implementation. And/or
(2) An amount of energy harvested by the passive tag 386 from the stimulus signal 452. For example, if only a small amount of energy can be harvested from the stimulus signal 452, the passive tag 386 may not have enough power to modulate and backscatter data in addition to the ID 458. In one example, if the harvested energy exceeds a predefined/preconfigured threshold, the apparatus 372 backscatters the data at step 536. Otherwise, the apparatus 372 does not backscatter the data and instead transmits the data at step 546. And/or
(3) A condition of a channel over which the backscatter is transmitted. For example, if the channel condition is good, the apparatus 372 may backscatter the data also, not just the ID 458, on the assumption that the data is more likely to be successfully received. In one example, if a reference signal received power (RSRP) exceeds a predefined/preconfigured threshold, the apparatus 372 backscatters the data at step 536. Otherwise, the apparatus 372 does not backscatter the data and instead transmits the data at step 546. And/or
(4) A parameter associated with the stimulus signal 452. For example, the device 352 may determine whether the apparatus 372 is to backscatter data along with the ID 458, and the device 352 may instruct the apparatus 372 by selecting a stimulus signal 452 having a parameter that maps to the instruction of “yes, backscatter data also” or “no, just backscatter the ID” based on a predefined mapping relationship (e.g. a look-up table). The parameter might be a time and/or frequency and/or sequence of the stimulus signal 452. The apparatus 372 selects whether or not to backscatter data in step 536 based on the detected parameter of the stimulus signal 452 and the predefined mapping relationship.

In some embodiments, the steps performed by the apparatus 372 in relation to FIG. 9 and its variations/examples may be performed by the processor 380 of the apparatus 372 executing processor-executable instructions stored in memory (e.g. in memory 382). The instructions, when executed, cause the apparatus 372 to perform the methods. In some embodiments, the apparatus 372 may refer to one or more circuit chips (e.g. housing processor 380) that cause the apparatus-side methods to be performed, and may exclude the circuitry related to transmitting and receiving (e.g. the antenna, RF chain, etc.).

In some embodiments, the steps performed by the device 352 in relation to FIG. 9 and its variations/examples may be performed by the processor 360 of the device 352 executing processor-executable instructions stored in memory (e.g. in memory 362). The instructions, when executed, cause the device 352 to perform the methods. In some embodiments, the device 352 may refer to one or more circuit chips (e.g. housing processor 360) that cause the device-side methods to be performed, and may exclude the circuitry related to transmitting and receiving (e.g. the antenna, RF chain, etc.).

Many variations and examples of FIG. 9 are described herein. Permutations of all of these variations and examples are contemplated. For example, any of the ways of communicating data may be combined with any of the ways of indicating the ID in the response, which may be combined with any of the ways of determining that the response indicates the ID, which may be combined with performing sensing, etc.

Embodiments herein may be applicable to networks in which a network device/terminal device can transmit/receive signals to/from another network device/terminal device, including but not limited to: (1) Cellular networks such as 4G long term evolution (LTE), 5G new radio (NR), 6G, etc.; and/or (2) Short-range communication systems, such as Bluetooth, WiFi, long range (LoRa), device-to-device (D2D), near-field communication (NFC), RFID, etc.; and/or (3) Internet of vehicle (IoV) systems such as vehicle-to-vehicle (V2V)/vehicle to everything (V2X), etc.; and/or (4) RF sensing systems; and/or (5) Integrated sensing and communication (ISAC) systems.

The device 352 and/or the apparatus 372 may be a network device, depending upon the embodiment. A network device may include any of the following devices: TRP (also called base station), node B (NB), evolved NB (eNB), gNB, NR-NB, home NB (HNB), base station controller (BSC), radio network controller (RNC), base transceiver station (BTS), access point (AP), integrated access and backhauling (IAB) node, base band unit (BBU), or any node that acts as a network device in the above wireless networks/systems.

The device 352 and/or the apparatus 372 may be a terminal device, depending upon the embodiment. A terminal device may include any of the following devices: UE, mobile station (MS), mobile terminal (MT), vehicle-mounted device, wearables, virtual reality (VR) device, augmented reality (AR) device, RFID, passive tag, relay, IoT device, wireless sensor, or any wireless device in smart home/industrial control/smart grid/smart logistics/smart warehousing/smart agriculture. Terminal device can be with power supply or with limited power supply (e.g., power supplied by a battery) or even without power supply (e.g., operating totally based on the energy harvested by the equipped passive tag). The methods herein may possibly be applied to terminal devices in radio resource control (RRC) connected state, inactive state, or idle state.

Technical benefits of some embodiments may include the following. The methods herein may possibly provide the ability for the apparatus 372 (e.g. terminal device) to achieve a low-power data transmission with the assistance of a passive tag. Compared to data transmission after or during a random-access procedure (such as the random-access procedure referenced in the “Background” of this patent application), data transmission after or during the method of FIG. 9 may consume less power, which is particularly beneficial if the apparatus 372 has a low-power requirement. In embodiments that include the ID acquisition period referred to earlier (e.g. the “second time duration” in Example 2 of FIG. 7), the configuring of different ID acquisition periods for different apparatuses may mitigate interference among the apparatuses if the ID acquisition periods of different apparatuses are non-overlapped. In examples in which the backscattered information in step 536 includes beam information in addition to ID 458, this may improve the reliability of the following transmissions to/from apparatus 372. In examples in which the backscattered information in step 536 includes an indication that the apparatus 372 has data to send (e.g. an access request), this may help avoid unnecessary access and thereby save power, e.g. by not performing steps 540 to 546 if the apparatus 372 has no data to send.

In addition to and consistent with the description above, the following examples are provided.

Example 1: A method performed by an apparatus having a passive tag, the method comprising: the passive tag backscattering information to a device in response to a stimulus signal, the information including an identifier (ID) associated with the apparatus; receiving a response from the device in response to backscattering the information; determining that the response indicates the ID.

Example 2: The method of Example 1, further comprising performing data communication with the device by at least one of: backscattering data along with the ID; receiving data in the response; or using the ID to perform the data communication subsequent to determining that the response indicates the ID.

Example 3: The method of Example 1 or Example 2, wherein the stimulus signal is a sensing signal that is to be reflected off of the apparatus.

Example 4: The method of any one of Examples 1 to 3, further comprising: receiving a message configuring a time duration; and configuring the passive tag to perform the backscattering of the information during the time duration.

Example 5: The method of Example 4, wherein prior to the time duration the stimulus signal is to be reflected off of the apparatus.

Example 6: The method of Example 4 or Example 5, wherein prior to the time duration the method comprises: in response to the stimulus signal, the passive tag performing backscattering without backscattering the information.

Example 7: The method of any one of Examples 1 to 6, wherein receiving the response comprises receiving control information that was scrambled using the ID, and wherein the response indicates the ID by scrambling the control information using the ID.

Example 8: The method of any one of Examples 1 to 6, wherein the response indicates the ID by including the ID in the response.

Example 9: The method of Example 8, wherein the method comprises: receiving control information that is scrambled using a predefined identifier, wherein the control information either includes the response or indicates a time-frequency location of the response.

Example 10: The method of Example 9, wherein the predefined identifier is a group-ID shared by a plurality of apparatuses including the apparatus, each of the plurality of apparatuses having a respective different passive tag.

Example 11: The method of Example 10, wherein the group-ID is either configured in advance or derived from the stimulus signal.

Example 12: The method of any one of Examples 1 to 11, wherein the response includes a timing advance (TA) value that was computed from at least one of: a reflected signal that is reflection of the stimulus signal off of the apparatus, or a backscatter caused by the stimulus signal.

Example 13: The method of any one of Examples 1 to 12, comprising using the ID to perform data communication with the device subsequent to determining that the response indicates the ID.

Example 14: The method of Example 13, wherein using the ID to perform the data communication comprises: receiving control information scrambled by the ID; obtaining from the control information an indication of a time-frequency location for transmitting or receiving data; subsequently transmitting or receiving the data at the time-frequency location.

Example 15: The method of Example 13 or Example 14, wherein the information backscattered additionally includes an indication that the apparatus has data to transmit to the device.

Example 16: The method of any one of Examples 1 to 15, wherein the stimulus signal is from a first device, the information is backscattered to a second device, and the response is received from the second device.

Example 17: The method of any one of Examples 1 to 16, further comprising determining whether to backscatter data along with the ID based on at least one of: an amount of the data to be transmitted; an amount of energy harvested by the passive tag from the stimulus signal; a condition of a channel over which the backscatter is transmitted; or a parameter associated with the stimulus signal.

Example 18: An apparatus comprising: a passive tag to backscatter information to a device in response to a stimulus signal, the information including an identifier (ID) associated with the apparatus; at least one processor; and a memory storing processor-executable instructions that, when executed by the at least one processor, cause the apparatus to: receive a response from the device in response to backscattering the information; determine that the response indicates the ID.

Example 19: The apparatus of Example 18, wherein the processor-executable instructions, when executed, further cause the apparatus to perform data communication with the device by at least one of: backscattering data along with the ID; receiving data in the response; or using the ID to perform the data communication subsequent to determining that the response indicates the ID.

Example 20: The apparatus of Example 18 or Example 19, wherein the stimulus signal is a sensing signal that is to be reflected off of the apparatus.

Example 21: The apparatus of any one of Examples 18 to 20, wherein the processor-executable instructions, when executed, further cause the apparatus to: receive a message configuring a time duration; and configure the passive tag to perform the backscattering of the information during the time duration.

Example 22: The apparatus of Example 21, wherein prior to the time duration the stimulus signal is to be reflected off of the apparatus.

Example 23: The apparatus of Example 21 or Example 22, wherein prior to the time duration: in response to the stimulus signal, the passive tag is to perform backscattering without backscattering the information.

Example 24: The apparatus of any one of Examples 18 to 23, wherein the apparatus is to receive the response by performing operations including receiving control information that was scrambled using the ID, and wherein the response indicates the ID by scrambling the control information using the ID.

Example 25: The apparatus of any one of Examples 18 to 23, wherein the response indicates the ID by including the ID in the response.

Example 26: The apparatus of Example 25, wherein the processor-executable instructions, when executed, cause the apparatus to: receive control information that is scrambled using a predefined identifier, wherein the control information either includes the response or indicates a time-frequency location of the response.

Example 27: The apparatus of Example 26, wherein the predefined identifier is a group-ID shared by a plurality of apparatuses including the apparatus, each of the plurality of apparatuses having a respective different passive tag.

Example 28: The apparatus of Example 27, wherein the group-ID is either configured in advance or derived from the stimulus signal.

Example 29: The apparatus of any one of Examples 18 to 28, wherein the response includes a timing advance (TA) value that was computed from at least one of: a reflected signal that is reflection of the stimulus signal off of the apparatus, or a backscatter caused by the stimulus signal.

Example 30: The apparatus of any one of Examples 18 to 29, wherein the processor-executable instructions, when executed, cause the apparatus to use the ID to perform data communication with the device subsequent to determining that the response indicates the ID.

Example 31: The apparatus of Example 30, wherein using the ID to perform the data communication comprises: receiving control information scrambled by the ID; obtaining from the control information an indication of a time-frequency location for transmitting or receiving data; subsequently transmitting or receiving the data at the time-frequency location.

Example 32: The apparatus of Example 30 or Example 31, wherein the information backscattered additionally includes an indication that the apparatus has data to transmit to the device.

Example 33: The apparatus of any one of Examples 18 to 32, wherein the stimulus signal is from a first device, the information is backscattered to a second device, and the response is received from the second device.

Example 34: The apparatus of any one of Examples 18 to 33, wherein the processor-executable instructions, when executed, further cause the apparatus to determine whether to backscatter data along with the ID based on at least one of: an amount of the data to be transmitted; an amount of energy harvested by the passive tag from the stimulus signal; a condition of a channel over which the backscatter is transmitted; or a parameter associated with the stimulus signal.

Example 35: A method performed by a device comprising: receiving information backscattered from a passive tag of an apparatus, the information backscattered in response to a stimulus signal, and the information including at least an identifier (ID) associated with the apparatus; in response to receiving the information, transmitting a response to the apparatus, the response indicating the ID.

Example 36: The method of Example 35, further comprising performing data communication with the apparatus by at least one of: receiving data backscattered from the apparatus along with the ID; transmitting data to the apparatus in the response; or using the ID to perform the data communication subsequent to transmitting the response.

Example 37: The method of Example 35 or Example 36, wherein the stimulus signal is a sensing signal, and wherein the method further comprises: receiving a reflected signal that is a reflection of the sensing signal off of the apparatus; and determining a parameter of the apparatus using the reflected signal.

Example 38: The method of Example 37, wherein the backscattered information is received during a time duration, and wherein prior to the time duration the reflected signal is received and the parameter of the apparatus is determined using the reflected signal.

Example 39: The method of any one of Examples 35 to 38, wherein transmitting the response comprises transmitting control information scrambled using the ID, and wherein the response indicates the ID by scrambling the control information using the ID.

Example 40: The method of any one of Examples 35 to 38, wherein the response indicates the ID by including the ID in the response.

Example 41: The method of Example 40, wherein the method comprises: transmitting control information that is scrambled using a predefined identifier, wherein the control information either includes the response or indicates a time-frequency location of the response.

Example 42: The method of Example 41, wherein the predefined identifier is a group-ID shared by a plurality of apparatuses including the apparatus, each of the plurality of apparatuses having a respective different passive tag.

Example 43: The method of Example 42, wherein the group-ID is either configured in advance or derived from the stimulus signal.

Example 44: The method of any one of Examples 35 to 43, wherein the response includes a timing advance (TA) value computed from at least one of: a reflected signal that is reflection of the stimulus signal off of the apparatus, or a backscatter caused by the stimulus signal.

Example 45: The method of any one of Examples 35 to 44, comprising using the ID to perform data communication with the apparatus subsequent to transmitting the response.

Example 46: The method of Example 45, wherein using the ID to perform the data communication comprises: transmitting control information scrambled using the ID, the control information including an indication of a time-frequency location for transmitting or receiving data; subsequently transmitting or receiving the data at the time-frequency location.

Example 47: The method of Example 45 or Example 46, wherein the information backscattered additionally includes an indication that the apparatus has data to transmit to the device.

Example 48: The method of any one of Examples 35 to 47, further comprising transmitting the stimulus signal and receiving the information backscattered in response to transmitting the stimulus signal.

Example 49: The method of Example 48, wherein a parameter associated with the stimulus signal indicates to the apparatus whether to backscatter data along with the ID.

Example 50: A device comprising: at least one processor; and a memory storing processor-executable instructions that, when executed by the at least one processor, cause the device to: receive information backscattered from a passive tag of an apparatus, the information backscattered in response to a stimulus signal, and the information including at least an identifier (ID) associated with the apparatus; in response to receiving the information, transmit a response to the apparatus, the response indicating the ID.

Example 51: The device of Example 50, wherein the processor-executable instructions, when executed by the at least one processor, further cause the device to perform data communication with the apparatus by at least one of: receiving data backscattered from the apparatus along with the ID; transmitting data to the apparatus in the response; or using the ID to perform the data communication subsequent to transmitting the response.

Example 52: The device of Example 50 or Example 51, wherein the stimulus signal is a sensing signal, and wherein the processor-executable instructions, when executed by the at least one processor, further cause the device to: receive a reflected signal that is a reflection of the sensing signal off of the apparatus; and determine a parameter of the apparatus using the reflected signal.

Example 53: The device of Example 52, wherein the backscattered information is received during a time duration, and wherein prior to the time duration the reflected signal is received and the parameter of the apparatus is determined using the reflected signal.

Example 54: The device of any one of Examples 50 to 53, wherein the device is to transmit the response by performing operations including transmitting control information scrambled using the ID, and wherein the response indicates the ID by scrambling the control information using the ID.

Example 55: The device of any one of Examples 50 to 53, wherein the response indicates the ID by including the ID in the response.

Example 56: The device of Example 55, wherein the processor-executable instructions, when executed by the at least one processor, cause the device to: transmit control information that is scrambled using a predefined identifier, wherein the control information either includes the response or indicates a time-frequency location of the response.

Example 57: The device of Example 56, wherein the predefined identifier is a group-ID shared by a plurality of apparatuses including the apparatus, each of the plurality of apparatuses having a respective different passive tag.

Example 58: The device of Example 57, wherein the group-ID is either configured in advance or derived from the stimulus signal.

Example 59: The device of any one of Examples 50 to 58, wherein the response includes a timing advance (TA) value computed from at least one of: a reflected signal that is reflection of the stimulus signal off of the apparatus, or a backscatter caused by the stimulus signal.

Example 60: The device of any one of Examples 50 to 59, wherein the processor-executable instructions, when executed by the at least one processor, cause the device to use the ID to perform data communication with the apparatus subsequent to transmitting the response.

Example 61: The device of Example 60, wherein using the ID to perform the data communication comprises: transmitting control information scrambled using the ID, the control information including an indication of a time-frequency location for transmitting or receiving data; subsequently transmitting or receiving the data at the time-frequency location.

Example 62: The device of Example 60 or Example 61, wherein the information backscattered additionally includes an indication that the apparatus has data to transmit to the device.

Example 63: The device of any one of Examples 50 to 62, wherein the processor-executable instructions, when executed by the at least one processor, further cause the device to transmit the stimulus signal and receive the information backscattered in response to transmitting the stimulus signal.

Example 64: The device of Example 63, wherein a parameter associated with the stimulus signal indicates to the apparatus whether to backscatter data along with the ID.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus including a passive tag, the method comprising:
backscattering, by the passive tag, information to a device in response to a stimulus signal, the information including an identifier (ID) associated with the apparatus;
receiving a response from the device in response to the backscattering the information; and
determining that the response indicates the ID.

2. The method of claim 1, further comprising:
performing data communication with the device by at least one of:
backscattering data along with the ID;
receiving data in the response; or
using the ID to perform the data communication subsequent to determining that the response indicates the ID.

3. The method of claim 1, wherein the stimulus signal is a sensing signal that is to be reflected off of the apparatus.

4. The method of claim 1, further comprising:
receiving a message indicating a time duration; and
configuring the passive tag to perform the backscattering the information during the time duration.

5. The method of claim 4, wherein prior to the time duration, the stimulus signal is to be reflected off of the apparatus.

6. The method of claim 4, wherein prior to the time duration, the method further comprises:
in response to the stimulus signal, performing, by the passive tag, backscattering without backscattering the information.

7. An apparatus comprising:
a passive tag to backscatter information to a device in response to a stimulus signal, the information including an identifier (ID) associated with the apparatus;
at least one processor coupled with a memory storing processor-executable instructions that, when executed by the at least one processor, cause the apparatus to:
receive a response from the device in response to backscattering the information; and
determine that the response indicates the ID.

8. The apparatus of claim 7, wherein the processor-executable instructions, when executed, further cause the apparatus to:
perform data communication with the device by at least one of:
backscattering data along with the ID;
receiving data in the response; or
using the ID to perform the data communication subsequent to determining that the response indicates the ID.

9. The apparatus of claim 7, wherein the stimulus signal is a sensing signal that is to be reflected off of the apparatus.

10. The apparatus of claim 7, wherein the processor-executable instructions, when executed, further cause the apparatus to:
receive a message indicating a time duration; and
configure the passive tag to perform backscattering the information during the time duration.

11. The apparatus of claim 10, wherein prior to the time duration the stimulus signal is to be reflected off of the apparatus.

12. The apparatus of claim 10, wherein prior to the time duration:
in response to the stimulus signal, the passive tag is to perform backscattering without backscattering the information.

13. The apparatus of claim 7, wherein the apparatus receives the response by performing operations including:
receiving control information that was scrambled using the ID, wherein the response indicates the ID by scrambling the control information using the ID.

14. A device comprising:
at least one processor coupled with a memory storing processor-executable instructions that, when executed by the at least one processor, cause the device to:
receive information backscattered from a passive tag of an apparatus, the information backscattered in response to a stimulus signal, and the information including at least an identifier (ID) associated with the apparatus; and
in response to the receiving the information, transmit a response to the apparatus, the response indicating the ID.

15. The device of claim 14, wherein the processor-executable instructions, when executed by the at least one processor, further cause the device to perform data communication with the apparatus by at least one of:
receiving data backscattered from the apparatus along with the ID;
transmitting data to the apparatus in the response; or
using the ID to perform the data communication subsequent to the transmitting the response.

16. The device of claim 14, wherein the stimulus signal is a sensing signal, and wherein the processor-executable instructions, when executed by the at least one processor, further cause the device to:
receive a reflected signal that is a reflection of the sensing signal off of the apparatus; and
determine a parameter of the apparatus using the reflected signal.

17. The device of claim 16, wherein the information is received during a time duration, and wherein, prior to the time duration the reflected signal is received, the parameter of the apparatus is determined using the reflected signal.

18. The device of claim 14, wherein the device transmits the response by performing operations including:
transmitting control information scrambled using the ID, wherein the response indicates the ID by scrambling the control information using the ID.

19. The device of claim 14, wherein the response indicates the ID by including the ID in the response.

20. The device of claim 19, wherein the processor-executable instructions, when executed by the at least one processor, further cause the device to:
transmit control information that is scrambled using a predefined identifier, wherein the control information either includes the response or indicates a time-frequency location of the response.
